(19) United States
(12) Patent Application Publication
(10) Pub. No.: US 2003/0178546 A1
(43) Pub. Date: Sep. 25, 2003

(54) Support/guide for reciprocally movable slats of the floor of loading/unloading spaces

(75) Inventors: Arian Heino De Raad, Coevorden (NL); Marc Mater, Hengelo (NL)

Correspondence Address: Ladas & Parry, 26 West 61st Street, New York, NY, 10023, US

(73) Assignee: CARGO FLOOR B.V.

(21) Appl. No.: 10/355,972

(22) Filed: Jan. 31, 2003

(30) Foreign Application Priority Data
Feb. 5, 2002 (NL) 1019901

(51) Int. Cl. F16M 11/00

(52) U.S. Cl. 248/694

(57) ABSTRACT

Support/guide for reciprocally movable slats of a floor of a cargo space, such as a lorry or trailer, or a loading/unloading station, the support/guide comprising a base strip for support on a cross girder of the floor, on which the base strip has been provided with a number of slat support members extending upwards from it and manufactured integrally therewith by moulding, particularly injection moulding, which slat support members are situated adjacent to each other and spaced apart in slat direction.

The invention relates to a support/guide for reciprocally movable slats of loading spaces, unloading spaces, storage spaces. Such floors are for instance known from lorries, trailers and self-unloading storage spaces.

It is known to support the slats for so-called reciprocally movable floors in a guiding manner on synthetic guides extending over the entire slat length, each guide being separately mounted on an accompanying longitudinal girder of the floor such as by means of clamping. A drawback of this is that a lot of material is necessary for the guides. Moreover, the entire guide will have to be replaced in case of local damage.

It is furthermore known to use short synthetic guides, which are only placed at the location where the aforementioned longitudinal girders are supported by cross girders of the floor. A drawback of this is that the mounting of the guide takes a lot of time.

It is an object of the invention to improve on this.

It is a further object of the invention to provide a support/guide of the type mentioned in the preamble, that can easily be adapted to the need.

It is a further object of the invention to provide a support/guide of the type mentioned in the preamble which is easy and quick to mount.

It is a further object of the invention to provide a support/guide of the type mentioned in the preamble, which renders the use of the aforementioned longitudinal girders superfluous.

It is a further object of the invention to provide a support/guide of the type mentioned in the preamble, which can be manufactured with a minimum quantity of material.

From one aspect the invention to that end provides a support/guide for reciprocally movable slats of a floor of a cargo space, such as a lorry or trailer, or a loading/unloading station, the support/guide comprising a base strip for support on a cross girder of the floor, on which the base strip has been provided with a number of slat support members extending upwards from it and manufactured integrally therewith by moulding, which slat support members are situated adjacent to each other and spaced apart in slat direction. The slat support members are supported on the cross girders via the base strip, so that the longitudinal girders are no longer needed to that end. By using a moulding process the support/guide can easily be manufactured in a shape/design/dimension adapted to what is needed.

Preferably the support/guide is manufactured by means of injection moulding. By means of injection moulding the support/guide can easily be made in a shape exactly adjusted to the floor in question and be mounted as a whole.

Preferably the support/guide is provided with at least four slat support members. This considerably facilitates the mounting of the floor, because many, for instance seven slat support members have been aligned beforehand.

Preferably at least one of the longitudinal edges the base strip is provided with stop means, particularly pendent stop strips. They can easily be injection moulded along, and are an aid in the correct placing of the base strip on the cross girder as well as a stop against axial displacement on it. In case both edges have been provided with stop means, the distance in between then preferably corresponds to the width of the cross girder.

Preferably the slat support members are provided with attachment holes extending through them and through the base strip, which attachment holes comprise a lower portion for accommodation of the head of an attachment means such as a blind rivet or bolt, and a broadened upper portion for accommodation of a contact portion of a tool for driving in the attachment means. This facilitates the mounting, in which the head of the tool can be centred.

Preferably the slat support members are provided with attachment holes extending through them and through the base strip, the attachment holes being staggered with respect to each other for adjacent slat support members, in a direction transverse to the base strip direction. As a result the attachment on an I-profile-shaped cross girder is improved, as the attachment means can for instance extend alternatingly adjacent to its web.

Preferably the slat support members have an upper portion flaring in transverse direction of the base strip, the flaring upper portion forming a slat support/guide surface at its upper surface. In this way—of so desired—a large support surface can be realised for improved support and guidance of the slats. The slat support/guide surface can be wider than the base strip.

Preferably the upper portion of the slat support members changes into a lower foot portion, which changes into the base strip and preferably has the same width as the base strip.

Preferably the slat support means have an upper portion widened with respect to the foot portion in longitudinal direction of the base strip, as a result of which the material is used where it is needed for support of the slats, and furthermore space is provided to possible bottom flanges of the slats, as may be usual.

Preferably the end edges of the slat support/guide surface that run parallel to the base strip are rounded off, so that as it were a pilot edge is provided, which facilitates the moving up of slats in longitudinal direction during mounting.

In an advantageous manner the supply of material during injection moulding takes place from the upper side of the slat support members. As a result the supply of material and the distribution in the mould is improved. Furthermore the shape of the base strip can easily be adapted by means of insert pieces, the shape of the slat support member not having to be changed.

It is possible for instance to have the supply of injection moulding material for adjacent slat support members take place at locations that are staggered with respect to each other, in a direction transverse to the base strip direction, just like in the case of the attachment holes mentioned earlier.

For increasing the grip on the cross girder it is advantageous when the lower side of the base strip is provided with longitudinal ribs.

Saving on material and weight is further improved when the slat support members comprise walls which leave hollow cavities free in between them.

From a further aspect the invention provides a support/guide for reciprocally movable slats of a floor of a cargo space, such as lorry or trailer, or a loading/unloading station, the support/guide comprising a base strip for support on a cross girder of the floor, on which the base strip has been provided with at least four slat support members extending upwards from it and integral therewith, which slat support members are situated adjacent to each other and spaced apart from each other in slat direction.

From a further aspect the invention provides a loading or storage space provided with a floor having reciprocally movable slats, the slats being supported on supports/guides according to the invention.

From yet a further aspect the invention provides a method for producing a support/guide for reciprocally movable slats of a floor of a cargo space, such as a lorry or trailer, or of a loading/unloading station, the support/guide comprising a base strip for support on a cross girder of the floor, on which the base strip has been provided with a number of slat support members extending upwards from it and integral therewith, which slat support members are spaced apart in strip direction, the support/guide being formed by injection moulding.

The invention will be elucidated on the basis of the exemplary embodiment shown in the attached drawings, in which:

FIG. 1 shows a side view of an exemplary embodiment of the support/guide according to the invention;

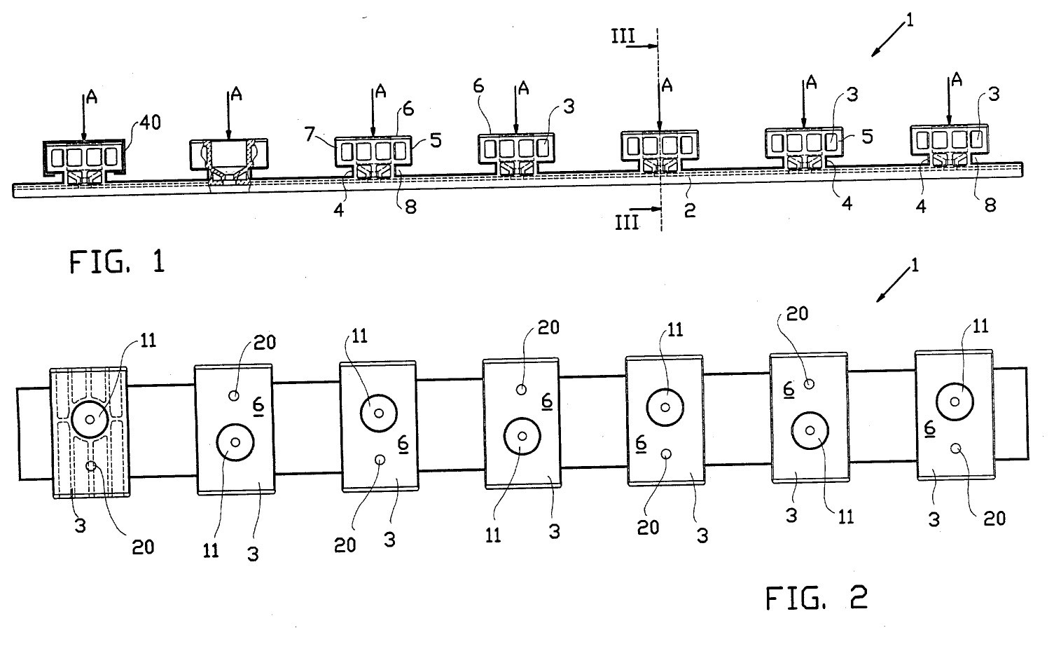

FIG. 2 shows a top view of the support/guide of FIG. 1;

FIG. 3 shows a side view of a slat support member of the support/guide according to FIGS. 1 and 2;

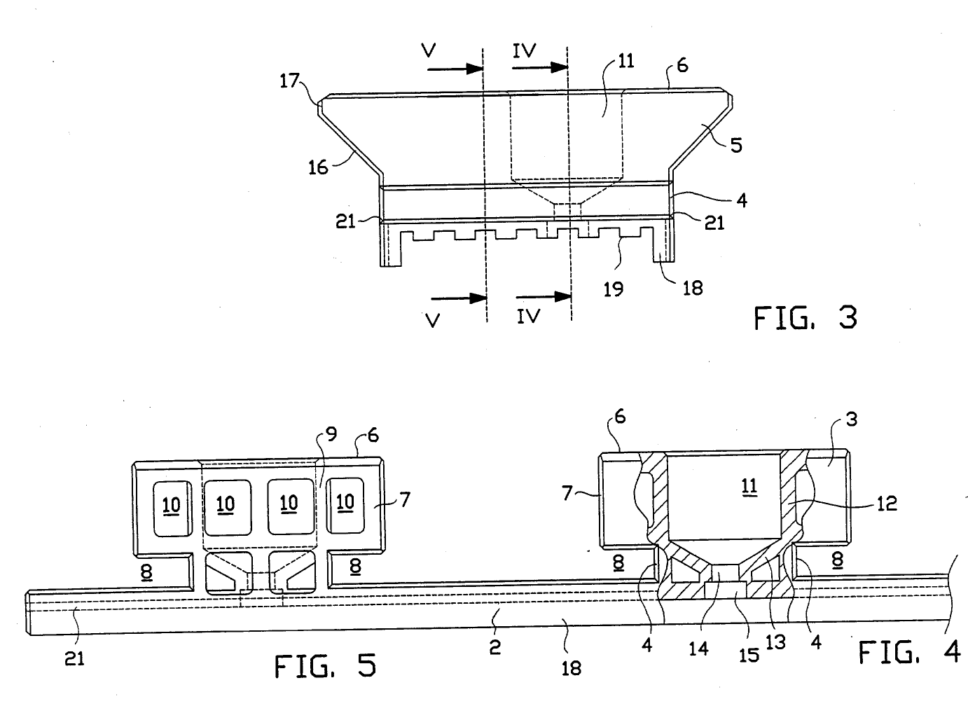

FIG. 4 shows a cross-section according to arrow IV-IV in FIG. 3;

FIG. 5 shows a cross-section according to arrow V-V of FIG. 3; and

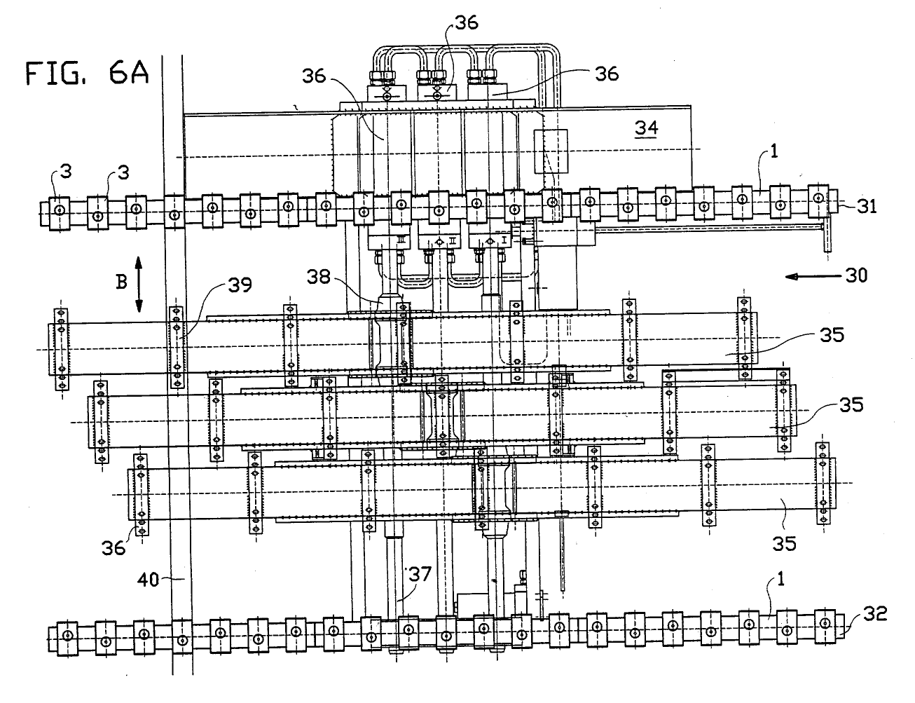

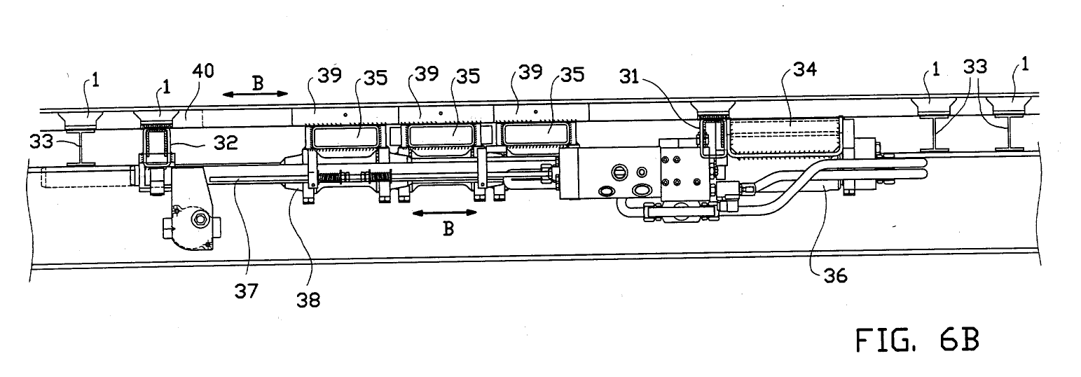

FIGS. 6A and 6B show the support/guide of the previous figures mounted in a (partially shown) floor of a cargo space.

The support/guide 1 of FIG. 1, is integrally formed from a suitable synthetic material such as HDPE, by means of injection moulding.

The support/guide 1 comprises an elongated base strip 2 having, as can be seen in FIG. 3, pendent edge strips 18, as placing aid, and longitudinal ribs 19 at the lower surface, for improvement of grip. The upper portions (surfaces) of the longitudinal edges of the base strip 2 are rounded off at the location of 21, as pilot edges for the slats during moving up during mounting and during use. At the upper side of the base strip 2—in this case—seven slat support members have been integrally formed, each consisting of a relatively narrow lower portion 4 and a relatively broad upper portion 5. The upper portion 5 forms a support and guide surface 6, which, as can be seen in FIG. 2, has a larger length than the width of the base strip 2. As can be seen in FIG. 3 the lower portion 4 has the same width as the base strip 2, and the upper portion 5 upwardly tapers off with inclined edges 16 into broadened surface 16, via rounded off pilot edges 17.

Both the lower portion 4 and the upper portion 5 have been provided with recesses, in the upper portion 5 by means of partitions 9, positioned between the side walls 7, and thus and with each other defining longitudinal chambers 10.

As can also be seen in FIG. 2, particularly in FIG. 4, at the location of each slat support member 3, vertical continuous holes have been provided in a staggered manner, considered in horizontal direction transverse to the longitudinal direction of the base strip 2, which continuous holes have a relative wide circular upper portion 11, surrounded by wall 12, than a conical portion defined by wall 13, and subsequently a circular end portion 14, and finally contiguously an enlarged hole 15 in the base plate 2. The portion 11 serves for accommodation of the head of for instance a tool for arranging blind rivets. The conical space serves for the accommodation of the head of the blind rivet, the other end of which engaging the counter surface of an upper wall of cross girder that is not further shown. The enlarged hole 15 may offer room to the burrs on the cross girders.

In FIG. 2 it can be seen that the holes 11 are staggered. The imprints 20 are also staggered, which imprints indicate where the injection mould gates were situated in the injection mould. During injection moulding material is supplied in the direction A (see FIG. 1) via the gates 20, in order to injection mould the entire support/guide 1. By means of suitable insert pieces in the mould the thickness of the base strip 2 as well as its shape (ribs or no ribs, no, one or two pendent edges 18) can be adjusted to the needs.

In FIG. 6A a top view is shown of a drive unit 30 of a so-called floor having reciprocally movable slats, which drive unit comprises three drive girders 35, each provided with a number of attachment sleeves 39, on which slats 40 can be attached (only one slat is shown), each drive girder 35 being driven by one of three cylinders 36. The cylinders 36 have been attached on a bridge girder 34. The piston rods 37 accompanying the cylinders 36 have each been attached to an accompanying drive girder 35 at the location of attachment 38, and at their ends are slideably supported in cross girder 32. Adjacent to bridge girder 34 cross girder 31 is present, also see FIG. 6B, in which the drive unit with contiguous parts of the loading floor is shown in vertical cross section.

In the FIGS. 6A and 6B it can be seen that on the cross girders 31 and 32 a number of supports/guides 1 of the previous figures have been attached. Furthermore it is shown in FIG. 6B that the same supports/guides 1 are also attached on the cross girders 33 of the loading floor. The slats 40 have moved up in longitudinal direction over the various consecutive slat support members 3 and over the finger 36 in question, and have been attached to the latter. When the drive girder 35 reciprocally moves, the slats 40 slide over the slat support members 3. In FIG. 1, left-hand side, a cross-section of slat 40 is schematically shown, in which it can be seen that it engages in the spaces 8 with the lower flanges.

1. Support/guide for reciprocally movable slats of a cargo supporting floor, the support/guide comprising a base strip for support on a cross girder of the floor, on which the base strip has been provided with a number of slat support members extending upwards from it and manufactured integrally therewith by moulding, which slat support members are situated adjacent to each other and spaced apart in slat direction.

2. Support/guide according to claim 1, the support/guide being manufactured by means of injection moulding.

3. Support/guide according to claim 1, provided with at least four slat support members.

4. Support/guide according to claim 1, the base strip at the longitudinal edges being provided with pendent stop means.

5. Support/guide according to claim 4, the pending stop means being formed as stop strips.

6. Support/guide according to claim 1, the slat support members being provided with attachment holes extending through them and through the base strip, which attachment holes comprise a lower portion for accommodation of the head of an attachment means, and an enlarged upper portion for accommodation of a contact portion of a tool for driving in the attachment means.

7. Support/guide according to claim 1, the slat support members being provided with attachment holes extending through them and through the base strip, the attachment holes being staggered with respect to each other for the adjacent slat support members, in a direction transverse to the base strip direction.

8. Support/guide according to claim 1, the slat support members having an upper portion flaring in transverse direction of the base strip, the flaring upper portion forming a slat support/guide surface at its upper surface.

9. Support/guide according to claim 8, the slat support/guide surface being wider than the base strip.

10. Support/guide according to claim 8, the upper portion of the slat support members changing into a lower foot portion, which changes into the base strip.

11. Support/guide according to claim 10, the lower foot portion having the same width as the base strip.

12. Support/guide according to claim 8, the slat support means having a upper portion widened with respect to the foot portion in longitudinal direction of the base strip.

13. Support/guide according to claim 8, the end edges of the slat support/guide surface that run parallel to the base strip being rounded off.

14. Support/guide according to claim 2, the supply of material during injection moulding having taken place from the upper side of the slat support members, wherein, preferably, the supply of injection moulding material for adjacent slat support members has taken place at locations that are staggered with respect to each other, in a direction transverse to the base strip direction.

15. Support/guide according to claim 14, the slat support members being provided with attachment holes extending through them and through the base strip, which attachment holes comprise a lower portion for accommodation of the head of an attachment means, and an enlarged upper portion for accommodation of a contact portion of a tool for driving in the attachment means, the supply locations and the attachment holes being alternatingly changed for adjacent slat support members.

16. Support/guide according to claim 1, the lower side of the base strip being provided with longitudinal ribs.

17. Support/guide according to claim 1, the base strip at the longitudinal edges of its upper surface being rounded off.

18. Guide/support according to claim 1, the base strip at the lower side being provided with an access to attachment holes, the access being enlarged.

19. Support/guide according to claim 1, the slat support members comprising walls which leave hollow cavities free in between them.

20. Loading or storage space provided with a floor having reciprocally movable slats, the slats being supported on supports/guides according to claim 1.

21. Support/guide for reciprocally movable slats of a cargo supporting floor, the support/guide comprising a base strip for support on a cross girder of the floor, on which the base strip has been provided with at least four slat support members extending upwards from it and integral therewith, which slat support members are situated adjacent to each other and spaced apart from each other in slat direction.

22. Loading or storage space provided with a floor having reciprocally movable slats, the slats being supported on supports/guides according to claim 21.

23. Method for producing a support/guide for reciprocally movable slats of a floor of a cargo space, such as a lorry or trailer, or of a loading/unloading station, the support/guide comprising a base strip for support on a cross girder of the floor, on which the base strip has been provided with a number of slat support members extending upwards from it and integral therewith, which slat support members are spaced apart in strip direction, the support/guide being formed by injection moulding.
